(19) United States
(12) Patent Application Publication
(10) Pub. No.: US 2008/0039018 A1
(43) Pub. Date: Feb. 14, 2008

(54) METHOD AND APPARATUS FOR AUTOMATIC CONNECTION BETWEEN MOBILE COMMUNICATION TERMINAL AND BLUETOOTH HANDSFREE DEVICE

(75) Inventor: Hak-Ryoul KIM, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/835,949

(22) Filed: Aug. 8, 2007

(30) Foreign Application Priority Data
Aug. 8, 2006 (KR) 74934-2006

(51) Int. Cl. H04B 7/00; H04M 1/00

(52) U.S. Cl. 455/41.2; 455/569.2

(57) ABSTRACT

Disclosed are a method and an apparatus for causing a vehicle Bluetooth handsfree device to be automatically connected to a mobile communication terminal. When the Bluetooth handsfree device is powered up, paging is performed for all mobile communication terminals registered in a handsfree user list stored in the Bluetooth handsfree device. If the number of terminals paged is one, Bluetooth-connection to a corresponding mobile communication terminal is performed. If the number of terminals paged is two or more, a list of paged terminals is provided to a user, and Bluetooth-connection to a selected mobile communication terminal is performed. In this way, even when multiple passengers are in a vehicle, Bluetooth-connection to a driver's mobile communication terminal can be automatically performed. Further, it is also possible to automatically perform Bluetooth-connection to a mobile communication terminal having not been most recently connected to a Bluetooth handsfree device.

### PRIORITY

This application claims priority to an application filed in the Korean Intellectual Property Office on Aug. 8, 2006 and assigned Serial No. 2006-74934, the contents of which are hereby incorporated by reference.

### BACKGROUND OF THE INVENTION

1. Field of the Invention

The present invention relates to a Bluetooth® (hereinafter “Bluetooth”) handsfree device, and more particularly to a method and an apparatus for causing a vehicle Bluetooth handsfree device to be automatically connected to a user terminal.

2. Description of the Related Art

A Bluetooth handsfree device mounted on a vehicle is wirelessly connected to a mobile communication terminal equipped with a Bluetooth module, and provides a handsfree function, so that a user can conveniently use the handsfree function without connection to another external device.

Specifically, a Bluetooth handsfree device causes a handsfree function to automatically interwork with the most recently connected mobile communication terminal. Even after Bluetooth-connection is terminated, the Bluetooth handsfree device stores connection information including unique Bluetooth addresses, authentication keys, and user names of mobile communication terminals having been connected through Bluetooth. Then, when the Bluetooth handsfree device is reset or powered up, it automatically attempts a connection by using connection information of the most recently connected mobile communication terminal from among the stored connection information. In this way, the Bluetooth handsfree device and the mobile communication terminal can be interconnected even without initiating by a user the interconnection.

According to a conventional automatic connection function, a connection with the most recently connected mobile communication terminal is unconditionally attempted. Accordingly, when a current driver is not the most recent driver who now as a fellow passenger gets in a vehicle, the current driver may not use a handsfree function, or the Bluetooth handsfree device may be automatically connected to the cell phone of the fellow passenger instead of the mobile terminal of the current driver.

### SUMMARY OF THE INVENTION

Accordingly, the present invention has been made to solve the above-mentioned problems occurring in the prior art, and it is an aspect of the present invention to provide a method and an apparatus for automatic connection of a Bluetooth handsfree device of a vehicle, which can automatically perform a Bluetooth-connection to a mobile communication terminal of the driver even when a plurality of passengers are in the vehicle.

It is another aspect of the present invention to provide a method and an apparatus capable of automatically performing a Bluetooth-connection to a terminal even when the terminal is not the mobile communication terminal most recently connected to a Bluetooth handsfree device.

In accordance with one aspect of the present invention, there is provided a method for automatically performing by a Bluetooth handsfree device mounted on a vehicle Bluetooth-connection to a mobile communication terminal equipped with a Bluetooth module, the method including performing Bluetooth paging from a Bluetooth handsfree device to registered mobile communication terminals by using previously stored connection information of the mobile communication terminals previously Bluetooth-connected to the Bluetooth handsfree device if the Bluetooth handsfree device is powered on,; providing a list of the paged mobile communication terminals if more than one mobile communication terminals have been paged as a result of the paging; and performing Bluetooth-connection to a mobile communication terminal selected from the list by a user of the Bluetooth handsfree device.

In accordance with another aspect of the present invention, there is provided a Bluetooth handsfree device mounted on a vehicle, the Bluetooth handsfree device including a Bluetooth module; a display unit; a speaker; a microphone; and a controller for controlling the Bluetooth module to perform paging for all registered mobile communication terminals by using previously stored connection information of all the mobile communication terminals previously Bluetooth-connected to the Bluetooth handsfree device, providing a list of two or more paged mobile communication terminals if the two or more mobile communication terminals have been paged as a result of the paging, and performing Bluetooth-connection to a mobile communication terminal selected from the list by a user of the Bluetooth handsfree device.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating installation example of a vehicle Bluetooth handsfree device to which the present invention is applied;

FIG. 2 is a block diagram illustrating the constructions of a Bluetooth handsfree device and a mobile communication terminal according to one embodiment of the present invention; and

FIG. 3 is a flow diagram illustrating the operation process of a Bluetooth handsfree device according to one embodiment of the present invention.

### DETAILED DESCRIPTION OF THE PREFERRED EMBODIMENT

A preferred embodiment of the present invention will be described in detail herein below with reference to the accompanying drawings. It should be noted that similar components are designated by similar reference numerals although they are illustrated in different drawings. Also, in the following description, a detailed description of known functions and configurations incorporated herein will be omitted for clarity and conciseness.

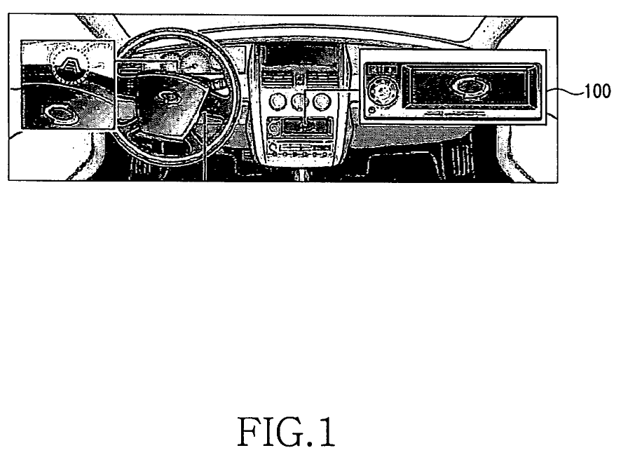

FIG. 1 is a diagram illustrating one example in which a Bluetooth handsfree device has been mounted on a vehicle. Referring to FIG. 1, the Bluetooth handsfree device 100 has a user interface including a display unit, input keys, etc. The Bluetooth handsfree device 100 is connected to a microphone and a speaker mounted in the vehicle, and interworks with a certain mobile communication terminal to provide a handsfree function. The Bluetooth handsfree device 100 has a connector for connection with an ear microphone, etc. The Bluetooth handsfree device 100 registers all previously connected mobile communication terminals in a handsfree user list. Herein, connection information corresponding to each mobile communication terminal is also registered in the handsfree user list. When the Bluetooth handsfree device 100 is reset or powered up according to the present invention, it attempts paging necessary for performing Bluetooth-connection to the mobile communication terminal registered in the user list. If a plurality of terminals have been paged as a result of the paging, the Bluetooth handsfree device 100 provides a user with a list of of the paged mobile communication terminals. However, if only one terminal has been paged, the Bluetooth handsfree device 100 performs Bluetooth-connection to the only one terminal.

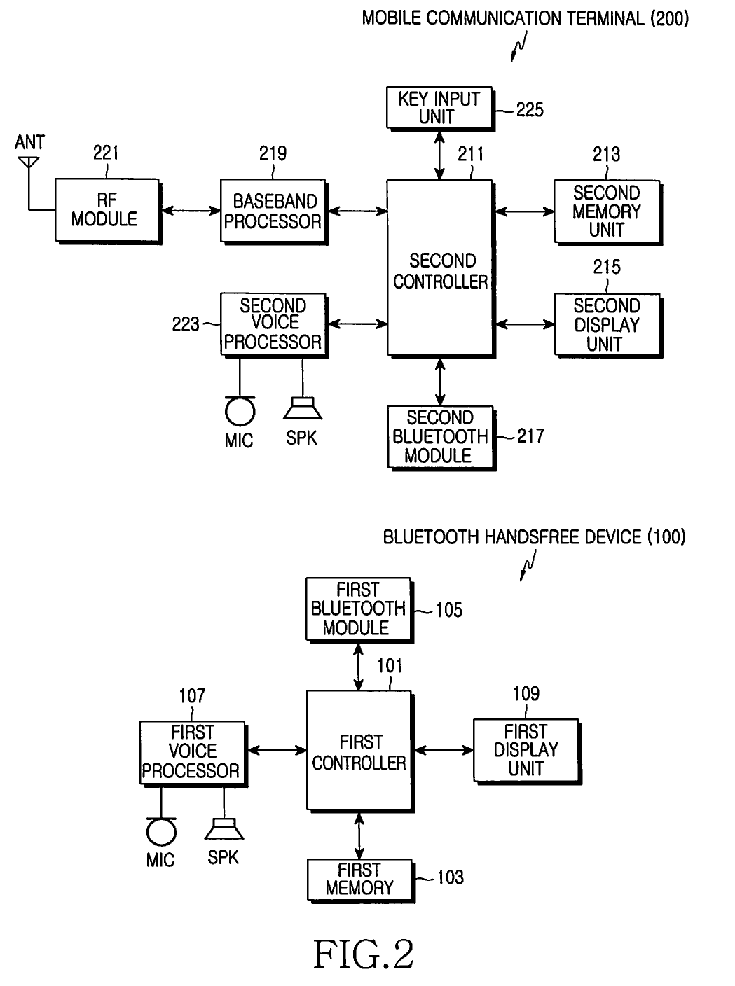

FIG. 2 is a block diagram illustrating the constructions of the Bluetooth handsfree device 100 and a mobile communication terminal 200 according to one embodiment of the present invention.

First, the construction of the mobile communication terminal 200 according to the present invention will be described with reference to FIG. 2. The mobile communication terminal 200 includes a second controller 211, a second memory unit 213, a second display unit 215, a key input unit 225, a baseband processor 219, a Radio Frequency (RF) module 221, a second voice processor 223, and a second Bluetooth module 217.

The second controller 211 controls the general operation of the mobile communication terminal 200. The second display unit 215 displays various pieces of image information, and images received from a base station or stored in the second memory unit 213 on a screen under the control of the second controller 211. The key input unit 225 has a * key, a # key, and a plurality of function keys such as a menu key, a selection key, a deletion key, a power on/off key, a volume key and a photographing key according to various functions provided by the mobile communication terminal 200. Further, the key input unit 225 provides key input data corresponding to keys pressed by a user to the second controller 211. The key input unit 225 has keys to which numerals 0 to 9 and a plurality of Hangeul or English letters have been allocated. The RF module 221 transmits/receives radio signals to/from a mobile communication base station through an antenna. The RF module 221 modulates RF transmission signals input from the second controller 211 through the baseband processor 219, and transmits the modulated RF signals through the antenna. Further, the RF module 221 demodulates RF signals received through the antenna, and provides the second controller 211 with the demodulated RF signals through the baseband processor 219. The baseband processor 219 processes baseband signals transmitted/received between the RF module 221 and the second controller 211. The second voice processor 223 connected to the second controller 211, and a microphone MIC/a speaker SPK connected to the second voice processor 223 are used for phone communication and voice recording. The second Bluetooth module 217 performs Bluetooth communication with another Bluetooth module, e.g. a first Bluetooth module 105 of the Bluetooth handsfree device 100. The second memory unit 213 stores programs for processing and control operations of the second controller 211, reference data, various updatable storage data, etc., and functions as a working memory of the second controller 211. Further, the second memory unit 213 stores program data based on a Bluetooth interworking mode.

When the mobile communication terminal 200 having the construction as described above is connected to the Bluetooth handsfree device 100 through the second Bluetooth module 217, the mobile communication terminal 200 sets a Bluetooth interworking mode. In the Bluetooth interworking mode, the mobile communication terminal 200 interworks with the Bluetooth handsfree device 100 to provide a communication service through the Bluetooth handsfree device 100. That is, when the Bluetooth interworking mode is set, the second controller 211 of the mobile communication terminal 200 controls call access of the mobile communication terminal 200 according to call access control data (e.g. originating request data, communication termination data) received from the Bluetooth handsfree device 100 through the second Bluetooth module 217. The second controller 211 transmits voice data received according to communication to the Bluetooth handsfree device 100, and processes voice data received from the Bluetooth handsfree device 100 to transmit the processed voice data to a terminal of a communication partner.

Referring to FIG. 2, the Bluetooth handsfree device 100 includes a first controller 101, a first memory unit 103, a first Bluetooth module 105, a first voice processor 107, a first display unit 109, and a key input unit (not shown). The first controller 101 controls the general operation of the Bluetooth handsfree device 100. The first Bluetooth module 105 performs Bluetooth under the control of the first controller 101. The first display unit 109 displays data received from an external Bluetooth module or data stored in the first memory unit 103 on a screen under the control of the first controller 101. The first voice processor 107 processes voice data received through the first Bluetooth module 105 to output the processed voice data to a speaker SPK connected thereto, and processes voice input through a microphone MIC to transmit the processed voice to the mobile communication terminal 200 through the first Bluetooth module 105, under the control of the first controller 101. The first memory unit 103 stores programs for processing and control operations of the first controller 101, reference data, various updatable storage data, etc., and functions as a working memory of the first controller 101. Further, the first memory unit 103 stores program data for automatic Bluetooth-connection and a handsfree user list. The handsfree user list is a list of all mobile communication terminals that have been connected to the Bluetooth handsfree device 100, and includes connection information corresponding to each of the mobile communication terminals. The connection information includes the Bluetooth device addresses of each mobile communication terminal, the user names of said each mobile communication terminal, and authentication keys.

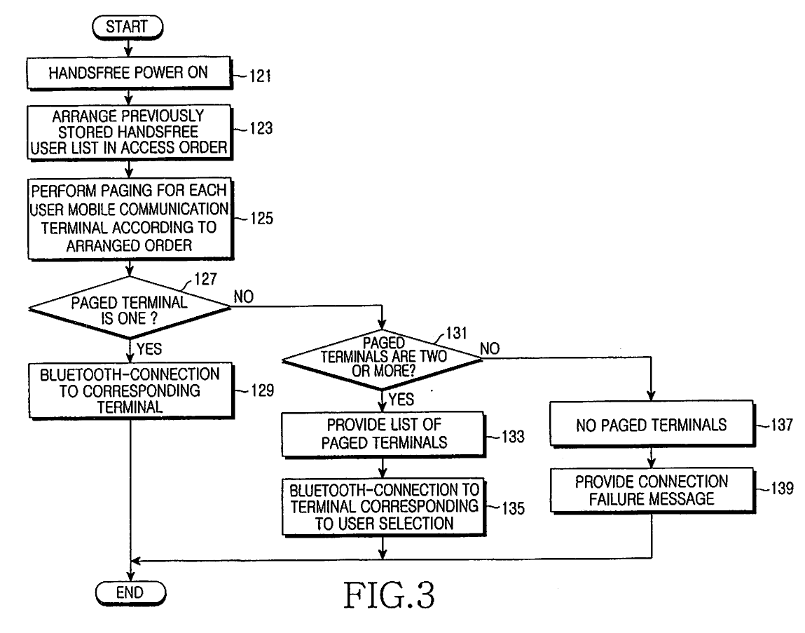

Hereinafter, an operation process of the vehicle Bluetooth handsfree device 100 having the construction as described above will be described with reference to FIG. 3. FIG. 3 is a flow diagram illustrating the operation process of the Bluetooth handsfree device 100 according to one embodiment of the present invention. Referring to FIG. 3, in step 121, the Bluetooth handsfree device 100 is powered up. In step 123, the Bluetooth handsfree device 100 arranges a previously stored handsfree user list in a prearranged access order. In step 125, the Bluetooth handsfree device 100 performs paging for Bluetooth-connection to each user mobile communication terminal by using connection information stored in the user list according to the prearranged order. In step 127, if only one terminal has been successfully paged, step 129 is performed. However, at step 131 if a plurality of terminals have been successfully paged, step 133 is performed. In step 129, the Bluetooth handsfree device 100 performs Bluetooth-connection to a corresponding terminal, and ends an operation process for the Bluetooth-connection. That is, if only the mobile communication terminal 200 is powered up and present in a vehicle equipped with the Bluetooth handsfree device 100, and the mobile communication terminal 200 has been registered in the Bluetooth user list of the Bluetooth handsfree device 100, the mobile communication terminal 200 and the Bluetooth handsfree device 100 are then automatically Bluetooth-connected, and the mobile communication terminal 200 sets a Bluetooth interworking mode to provide a handsfree function to a user.

In step 127, if the number of terminals successfully paged is not one, step 131 is performed. That is, the Bluetooth handsfree device 100 determines if two or more terminals have been paged. If two or more terminals have been paged, the Bluetooth handsfree device 100 provides a user with a list of paged terminals in step 133. Herein, the list of paged terminals may be provided through the first display unit 109, or by voice. The user of the Bluetooth handsfree device 100 selects from the provided list a terminal to be connected to the Bluetooth handsfree device 100. That is, the user may select the terminal from a plurality of connectable terminals. In step 135, the Bluetooth handsfree device 100 performs Bluetooth-connection to the terminal corresponding to the user selection, and ends the Bluetooth-connection process.

For example, if a plurality of mobile communication terminals including the mobile communication terminal 200 exist in a vehicle, and the mobile communication terminals have been previously registered in the handsfree user list, the Bluetooth handsfree device 100 can perform paging for all the mobile communication terminals. In this way, the Bluetooth handsfree device 100 provides a user with a list of all the mobile communication terminals presently in the vehicle, and performs Bluetooth-connection to one mobile communication terminal selected by the user.

However, if no previously registered terminal is found paged in step 137, the Bluetooth handsfree device 100 notifies a user of connection failure in step 139, and ends the operation process.

According to the present invention as described above, when the Bluetooth handsfree device 100 is powered up, paging is performed for all mobile communication terminals registered in a handsfree user list stored in the Bluetooth handsfree device 100. As a result of the paging, if the number of terminals paged is one, Bluetooth-connection to the one mobile communication terminal is performed. If the number of terminals paged is more than one, a list of paged terminals is provided to a user, and Bluetooth-connection to a selected mobile communication terminal is performed. In this way, even when multiple passengers are in a vehicle, Bluetooth-connection to a driver's mobile communication terminal can be automatically performed. Further, it is also possible to automatically perform Bluetooth-connection to a mobile communication terminal having not been most recently connected to a vehicle Bluetooth handsfree device.

Although a preferred embodiment of the present invention has been described for illustrative purposes, those skilled in the art will appreciate that various modifications, additions and substitutions are possible, without departing from the scope and spirit of the present invention as disclosed in the accompanying claims, including the full scope of equivalents thereof.

What is claimed is:

1. A method for automatically performing by a Bluetooth handsfree device mounted in a vehicle Bluetooth-connection to a mobile communication terminal equipped with a Bluetooth module, comprising:
performing Bluetooth paging for registered mobile communication terminals by using previously stored connection information of the mobile communication terminals previously Bluetooth-connected to the Bluetooth handsfree device when the Bluetooth handsfree device is powered up;
determining the number of Bluetooth connectable terminals by performing Bluetooth paging;
if only one mobile communication terminal has been paged as a result of the paging, performing Bluetooth-connection to the only one mobile communication terminal;
providing a list of paged mobile communication terminals if two or more registered mobile communication terminals have been paged; and
performing Bluetooth-connection to a mobile communication terminal selected from the list by a user of the Bluetooth handsfree device.

2. The method as claimed in claim 1, wherein the connection information comprises Bluetooth device addresses corresponding to each registered mobile communication terminal, user names of said each registered mobile communication terminal, and authentication keys.

3. The method as claimed in claim 2, further comprising, if there is no paged mobile communication terminal as a result of the paging, notifying the user of failure of the Bluetooth-connection.

4. A Bluetooth handsfree device mounted in a vehicle, comprising:
a Bluetooth module;
a display unit;
a speaker;
a microphone; and
a controller for controlling the Bluetooth module to perform paging for all registered mobile communication terminals previously Bluetooth-connected to the Bluetooth handsfree device by using previously stored connection information of the registered mobile communication terminals, determining the number of Bluetooth connectable terminals by performing Bluetooth paging, if only one mobile communication terminal has been paged as a result of the paging, the controller performs Bluetooth-connection to the only one mobile communication terminal, providing a list of paged mobile communication terminals if two or more mobile communication terminals have been paged as a result of the paging, and performing Bluetooth-connection to a mobile communication terminal selected from the list by a user of the Bluetooth handsfree device.

5. The Bluetooth handsfree device as claimed in claim 4, wherein the connection information includes Bluetooth device addresses corresponding to each registered mobile communication terminal, user names of said each registered mobile communication terminal, and authentication keys.

6. The Bluetooth handsfree device as claimed in claim 5, wherein, if there is no paged mobile communication terminal as a result of the paging, the controller notifies the user of failure of the Bluetooth-connection.
